(19) United States
(12) Patent Application Publication
(10) Pub. No.: US 2021/0396397 A1
(43) Pub. Date: Dec. 23, 2021

(54) REFRIGERATING MACHINE, HOT WATER HEAT PUMP, OPERATING METHOD AND PROGRAM

(71) Applicant: MITSUBISHI HEAVY INDUSTRIES THERMAL SYSTEMS, LTD., Tokyo (JP)

(72) Inventors: Yoshie TOGANO, Tokyo (JP); Takaaki MIURA, Tokyo (JP); Yasushi HASEGAWA, Tokyo (JP)

(73) Assignee: MITSUBISHI HEAVY INDUSTRIES THERMAL SYSTEMS, LTD., Tokyo (JP)

(21) Appl. No.: 16/498,955

(22) PCT Filed: Mar. 9, 2018
(86) PCT No.: PCT/JP2018/009236

§ 371 Date: Sep. 27, 2019

(30) Foreign Application Priority Data
Mar. 31, 2017 (JP) 2017-071294

(51) Int. Cl. F24D 19/10; F25B 49/02; F24D 17/02; G01L 27/00; G01L 13/00

(52) U.S. Cl. CPC F24D 19/1054; F25B 49/02; F25B 2700/19; G01L 27/00; G01L 13/00; F24D 17/02

(57) ABSTRACT

A refrigerating machine (1) is equipped with a condenser (3) through which a low-pressure refrigerant flows inside, an intermediate cooler (4), an evaporator (5), and a sensor of the atmosphere open type which is attached to at least one of the condenser (3), the intermediate cooler (4), and the evaporator (5) to measure the pressure inside at least one of the condenser (3), the intermediate cooler (4) and the evaporator (5), and a correcting unit which is configured to correct an atmospheric pressure which is a reference value of the sensor by acquiring the atmospheric pressure of a location in which the refrigerating machine (1) is installed.

### TECHNICAL FIELD

The present invention relates to a refrigerating machine, a hot water heat pump, and an operating method, and a program therefor.

Priority is claimed on Japanese Patent Application No. 2017-071294, filed Mar. 31, 2017, the content of which is incorporated herein by reference.

### BACKGROUND ART

In the field of refrigerating machines, the pressure and temperature of a refrigerating machine are kept within a desired range by control and protection operations for the refrigerating machine being performed. The pressures of respective constituent elements such as a condenser, an evaporator, and an intermediate cooler are used for these control and protection operations. The measurement of pressure is often performed using a pressure transmitter using a shielded gauge pressure in a high-pressure refrigerant, and is often performed using a pressure transmitter having a gauge pressure (sensor) of a type open to the atmosphere in a low-pressure refrigerant. The sensor of a type open to the atmosphere measures a pressure difference between the pressure in the condenser, the evaporator, and the intermediate cooler and atmospheric pressure as a reference value.

Also, the temperature in a refrigerating machine is also measured using these measured pressures. Protection is performed to prevent damage to the refrigerating machine. If the pressure of any of respective constituent elements in the refrigerating machine becomes too high, there is a likelihood that the constituent elements in the refrigerating machine will rupture. Moreover, if the temperature of the refrigerating machine becomes too low, there is a likelihood that the refrigerating machine may be damaged. Since the refrigerating machine controls the operation of the respective constituent elements according to the measured pressures and temperature, if the pressures cannot be measured accurately, it may be difficult for the respective constituent elements to be operated appropriately.

The atmospheric pressure serving as a reference value for a sensor of a type open to the atmosphere needs to be constant regardless of an environment in which the refrigerating machine is used and a location at which the refrigerating machine is installed (for example, atmospheric pressure should be constant at a standard atmospheric pressure (about 1013 hpa)). However, for example, when the refrigerating machine is used at a location with a high altitude such as an upper floor of a building or a city in a mountainous area, atmospheric pressure at the location at which the refrigerating machine is installed is lower than standard atmospheric pressure. In this case, the pressure in the refrigerating machine is measured as being higher than the actual pressure. Conversely, when atmospheric pressure at a location at which the refrigerating machine is installed is higher than standard atmospheric pressure, the pressure in the refrigerating machine is measured as being lower than the actual pressure. Further, atmospheric pressure also fluctuates, for example, depending on the weather such as in approach of a typhoon. The annual variation in the daily average value of atmospheric pressure fluctuates from −2.4 kPa to 1.7 kPa with respect to standard atmospheric pressure, and when the altitude is between 0 m and 1000 m, atmospheric pressure fluctuates by 11.3 kPa with respect to standard atmospheric pressure. In this way, if the location in which a refrigerating machine is installed or the weather changes, the refrigerating machine may not be able to obtain the same measured results, and it becomes difficult to accurately measure the pressure in the device.

When the refrigerant used in a refrigerating machine is a high-pressure refrigerant (a refrigerant used at a relatively high pressure), since the pressure inside the refrigerating machine is high, even if the atmospheric pressure fluctuates in a situation in which a sensor of the atmosphere open type is used, this has little influence thereon. However, when the refrigerant used in the refrigerating machine is a low-pressure refrigerant (a refrigerant used at a relatively low pressure), a deviation from standard atmospheric pressure in the reference value of the sensor greatly affects on the measurement of the pressure of the refrigerating machine. As an example, when the refrigerating machine is installed at an altitude of about 1000 m and a typhoon passes, if the temperature in the evaporator is measured from the measured pressure in the evaporator, the actual temperature is 5° C., and meanwhile, the measured temperature becomes 9.8° C.

Regarding control in which atmospheric pressure is used, Patent Literature 1 discloses that atmospheric pressure is acquired by an air pressure sensor, the weather is predicted from the acquired atmospheric pressure, and a set inside temperature is corrected on the basis of the predicted weather.

### CITATION LIST

### Patent Literature

[Patent Literature 1]

Japanese Unexamined Patent Application, First Publication No. 2014-040978

### SUMMARY OF INVENTION

### Technical Problem

An object of the present invention is to provide a refrigerating machine, a hot water heat pump, an operating method and a program in which the accuracy of measurement of the pressure in a refrigerating machine or a hot water heat pump can be improved, by reducing the influence of fluctuation in atmospheric pressure due to the location at which the refrigerating machine or the hot water heat pump is installed and the fluctuation of the atmospheric pressure due to the weather.

### Solution to Problem

In order to solve the above problems, the present invention adopts the following means.

That is, according to an aspect of the present invention, a refrigerating machine is equipped with a centrifugal compressor which is configured to compress a refrigerant; a condenser and an evaporator through which the refrigerant flows; a sensor attached to at least one of the condenser and the evaporator, the sensor being a sensor of the atmosphere open type configured to measure a pressure inside at least one of the condenser and the evaporator; and a correcting unit which is configured to correct an atmospheric pressure which is a reference value of the sensor by acquiring an atmospheric pressure of a location in which the refrigerating machine is installed.

According to this configuration, a measured value of the sensor can be corrected using the atmospheric pressure of the location in which the refrigerating machine is installed.

Further, according to an aspect of the present invention, the correcting unit may be an atmospheric pressure gauge, and the atmospheric pressure which is a reference value of the sensor may be corrected using a difference between the atmospheric pressure indicated by the atmospheric pressure gauge and a standard atmospheric pressure.

According to this configuration, the measured value of the sensor is corrected using the current atmospheric pressure of the location in which the refrigerating machine is installed.

Moreover, according to an aspect of the present invention, the refrigerating machine may further include an acquisition unit configured to acquire an altitude of a location in which the refrigerating machine is installed from a predetermined database, on the basis of position information of the location in which the refrigerating machine is installed. Further, the correcting unit may calculate the atmospheric pressure of the location in which the refrigerating machine is installed on the basis of the altitude acquired by the acquisition unit, and an atmospheric pressure which is a reference value of the sensor may be corrected, using a difference between the atmospheric pressure of the location in which the refrigerating machine is installed and the standard atmospheric pressure.

According to this configuration, the measured value of the sensor is corrected without installing an atmospheric pressure gauge in the refrigerating machine.

Moreover, according to an aspect of the present invention, in the above refrigerating machine, the refrigerant may be a low-pressure refrigerant in which a pressure at the time of rated operation is 0.2 MPa or less.

Moreover, according to an aspect of the present invention, a hot water heat pump is equipped with a centrifugal compressor which is configured to compress refrigerant; a condenser and an evaporator through which the refrigerant flows inside; a sensor attached to at least one of the condenser and the evaporator, the sensor being a sensor of the atmosphere open type configured to measure a pressure inside at least one of the condenser and the evaporator; and a correcting unit which is configured to correct an atmospheric pressure which is a reference value of the sensor, by acquiring the atmospheric pressure of a location in which the hot water heat pump is installed.

Further, according to an aspect of the present invention, the correcting unit may be an atmospheric pressure gauge, and the atmospheric pressure which is a reference value of the sensor may be corrected, using a difference between the atmospheric pressure indicated by the atmospheric pressure gauge and a standard atmospheric pressure.

Moreover, according to an aspect of the present invention, the hot water heat pump may be further equipped with an acquisition unit configured to acquire an altitude of a location in which the hot water heat pump is installed from a predetermined database, on the basis of position information of the location in which the hot water heat pump is installed, in which the correcting unit may calculate the atmospheric pressure of the location in which the hot water heat pump is installed on the basis of the altitude acquired by the acquisition unit, and an atmospheric pressure which is a reference value of the sensor may be corrected using a difference between the atmospheric pressure of the location in which the hot water heat pump is installed and a standard atmospheric pressure.

Further, according to an aspect of the present invention, in the above-described hot water heat pump, the refrigerant may be a low-pressure refrigerant in which a pressure at the time of rated operation is 0.2 MPa or less.

Moreover, according to an aspect of the present invention, an operating method of a refrigerating machine or a hot water heat pump equipped with a centrifugal compressor configured to compress a refrigerant, a condenser and an evaporator, the refrigerant flowing inside the condenser and the evaporator, and a sensor of the atmosphere open type attached to at least one of the condenser and the evaporator, includes: a pressure measurement step of measuring a pressure inside at least one of the condenser and the evaporator, using the sensor; an atmospheric pressure acquisition step of acquiring an atmospheric pressure of a location in which the refrigerating machine or the hot water heat pump is installed; a correction step of correcting an atmospheric pressure which is a reference value of the sensor and a measured value of the sensor, using the atmospheric pressure acquired in the step of acquiring the atmospheric pressure; and a control step of controlling the operation of the refrigerating machine or the hot water heat pump, using a corrected measured value of the sensor.

According to this configuration, the measured value of the sensor can be corrected, using the atmospheric pressure of the location in which the refrigerating machine or the hot water heat pump is installed.

Further, according to an aspect of the present invention, an atmospheric pressure gauge may be used in the atmospheric pressure acquisition step, and the atmospheric pressure which is a reference value of the sensor may be corrected, using a difference between the atmospheric pressure indicated by the atmospheric pressure gauge and a standard atmospheric pressure, in the correction step.

According to this configuration, the measured value of the sensor is corrected using the current atmospheric pressure of the location in which the refrigerating machine or the hot water heat pump is installed.

Further, according to an aspect of the present invention, the atmospheric pressure acquisition step may have an acquisition step of acquiring an altitude of a location in which the refrigerating machine or the hot water heat pump is installed from a predetermined database, on the basis of position information of the location in which the refrigerating machine or the hot water heat pump is installed; and an atmospheric pressure calculating step of calculating an atmospheric pressure of the location in which the refrigerating machine or the hot water heat pump is installed, on the basis of the altitude acquired in the acquisition step. Further, in the correction step, the atmospheric pressure which is a reference value of the sensor may be corrected, using a difference between the atmospheric pressure of the location in which the refrigerating machine or the hot water heat pump is installed and a standard atmospheric pressure.

According to this configuration, the measured value of the sensor is corrected without installing an atmospheric pressure gauge in the refrigerating machine or the hot water heat pump.

Further, according to another aspect of the present invention, a program causes a control device of a refrigerating machine or a hot water heat pump equipped with a centrifugal compressor configured to compress a refrigerant, a condenser and an evaporator, the refrigerant flowing inside the condenser and the evaporator, and a sensor of the atmosphere open type attached to at least one of the condenser and the evaporator to function as a pressure measurement unit which is configured to measure a pressure inside at least one of the condenser and the evaporator, using the sensor, an atmospheric pressure acquisition unit which is configured to acquire an atmospheric pressure of a location in which the refrigerating machine or the hot water heat pump is installed, a correction unit which is configured to correct an atmospheric pressure which is a reference value of the sensor and a measured value of the sensor, using the atmospheric pressure acquired in a step of acquiring the atmospheric pressure; and a control unit which is configured to control the operation of the refrigerating machine or the hot water heat pump, using a corrected measured value of the sensor.

### Advantageous Effects of Invention

According to the refrigerating machine, the hot water heat pump, the operating method, and the program of the present invention, it is possible to correct error in a sensor caused by the environment in which the refrigerating machine or the hot water heat pump is installed, and control the refrigerating machine or the hot water heat pump to operate more appropriately.

### BRIEF DESCRIPTION OF DRAWINGS

FIG. 1 is a perspective view of a refrigerating machine according to a first embodiment.

FIG. 2 is a perspective view of a sensor according to the first embodiment.

FIG. 3 is a flowchart for correcting a pressure measured value in the refrigerating machine by correcting the atmospheric pressure, which is a reference value of a sensor of the atmosphere open type, in the first embodiment.

FIG. 4 is a configuration diagram of a hot water heat pump according to a third embodiment.

### DESCRIPTION OF EMBODIMENTS

### First Embodiment

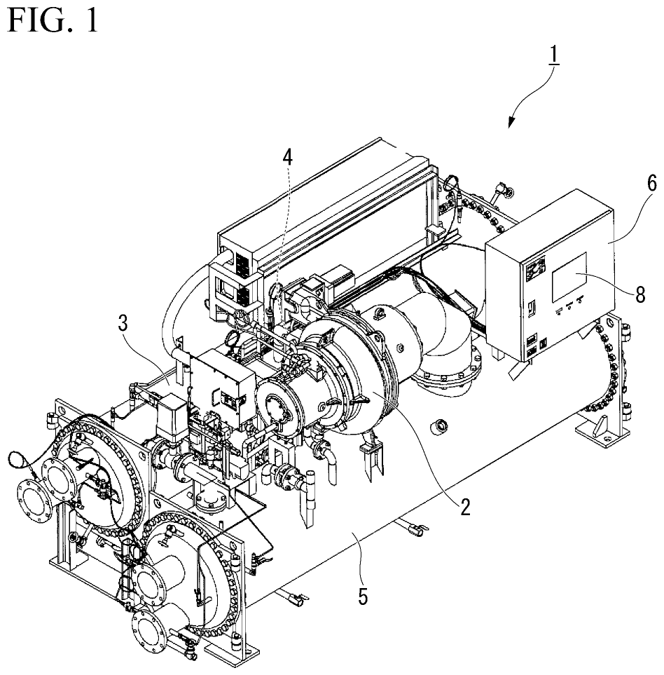

FIG. 1 is a perspective view of a refrigerating machine of the present invention.

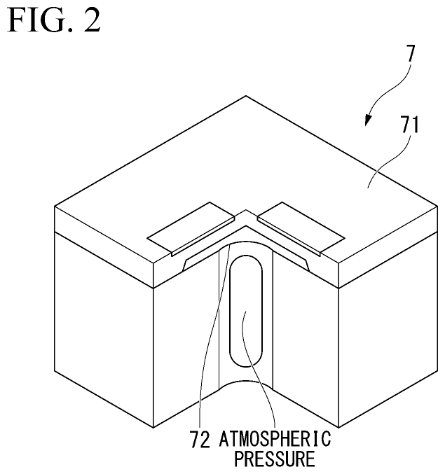

FIG. 2 is a perspective view of a sensor of the present invention.

Hereinafter, embodiments of a refrigerating machine 1 of the present invention will be described in detail with reference to the drawings.

As shown in FIG. 1, the refrigerating machine 1 according to the first embodiment is equipped with a centrifugal compressor 2 for compressing a gaseous refrigerant, a condenser 3 for distributing and condensing heat of the compressed gaseous refrigerant, an intermediate cooler 4 that performs intermediate cooling of condensed liquid refrigerant, and an evaporator 5 that absorbs heat from the condensed refrigerant and vaporizes it.

The refrigerant used in the present embodiment is a low-pressure refrigerant in which a pressure at the time of a rated operation is 0.2 MPa or less (this is defined by the High-Pressure Gas Safety Law). The pressure of the refrigerant used in the present embodiment does not exceed 0.2 MPa at the time of operation of the refrigerating machine 1. The refrigerating machine 1 of the present embodiment performs a refrigerating cycle which is well known to those skilled in the art.

Furthermore, the refrigerating machine 1 is equipped with a control device 6 for controlling the operation of the entire refrigerating machine 1.

The control device 6 may have an aspect which includes, for example, a microcomputer, and exhibits a control function by operating the microcomputer in accordance with a program prepared in advance.

Further, although the refrigerating machine 1 of the present embodiment is further equipped with an electric motor, a sub-cooler, an oil tank, an automatic temperature control device, an inverter, a bleed device, and the like, since these constituent elements are well known to those skilled in the art, and do not constitute the gist of the present invention, they will not be described in detail in this specification.

In addition, although the refrigerant used for the refrigerating machine 1 according to the present embodiment was described as a low-pressure refrigerant in which the pressure at the time of rated operation is 0.2 MPa or less, it is not limited to this aspect in other embodiments. That is, the refrigerating machine 1 according to other embodiments may be equipped with a refrigerant in which the pressure at the time of rated operation exceeds 0.2 MPa.

The refrigerating machine 1 of the present embodiment is equipped with a pressure transmitter attached to each of the condenser 3, the intermediate cooler 4, and the evaporator 5 to measure the pressure inside the condenser 3, the intermediate cooler 4, and the evaporator 5. In the present embodiment, the pressure transmitter is equipped with an atmospheric open type sensor 7 as shown in FIG. 2. The sensor 7 is equipped with a first face 71 that faces each constituent element (the condenser 3, the intermediate cooler 4, and the evaporator 5) of the refrigerating machine 1, and a second face 72 that is provided on a side opposite to the first face 7 land receives atmospheric pressure. The sensor 7 measures a differential pressure between the pressures received by the first face 71 from the condenser 3, the intermediate cooler 4 and the evaporator 5 and the pressure received by the second face 72 with the atmospheric pressure as a reference value. In FIG. 2, atmospheric pressure is applied to the second face 72 from an opening portion provided below the sensor 7, and the pressure in the condenser 3, the intermediate cooler 4, and the evaporator 5 is applied to the first face 71 located above the sensor 7. The pressure in the condenser 3, the intermediate cooler 4 and the evaporator 5 measured by the sensor 7 is transmitted to the control device 6.

The control device 6 measures the pressure inside the condenser 3, the intermediate cooler 4 and the evaporator 5 (and the temperature corresponding to the pressure) on the basis of the pressure measured by the sensor 7. In addition, the control device 6 controls the operation of a centrifugal compressor provided in the refrigerating machine 1 and the opening degrees of various valves to maintain the internal pressure and temperature of the condenser 3, the intermediate cooler 4 and the evaporator 5 within the desired ranges of the pressure and temperature.

The refrigerating machine 1 of the present embodiment is equipped with an atmospheric pressure gauge 8 attached to a substrate of the control device 6. The atmospheric pressure gauge 8 constitutes correcting means for correcting the atmospheric pressure that serves as a reference value for the sensor 7 to reduce the influence of fluctuations in atmospheric pressure due to the location in which the refrigerating machine 1 is installed and the weather on the measured values of the sensor 7. The control device 6 is electrically connected to the atmospheric pressure gauge 8 and continuously refers to the measured values of the atmospheric pressure gauge 8. Therefore, the control device 6 is configured so that the measured values of the atmospheric pressure gauge 8 may be used for control of the refrigerating machine 1 in real time.

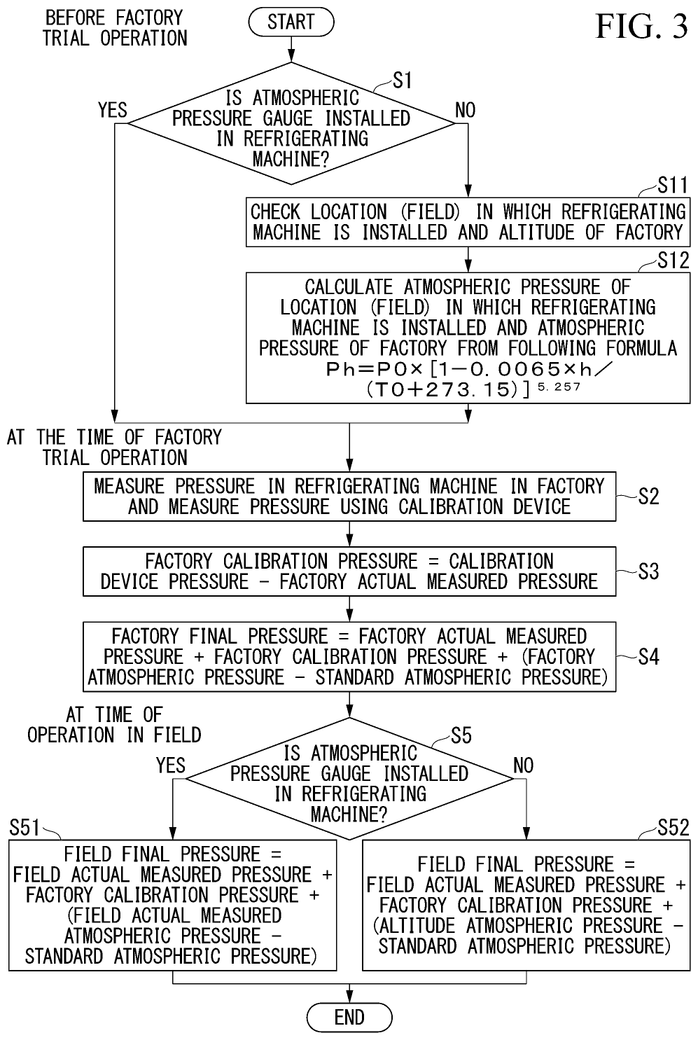

FIG. 3 is a flowchart for correcting the pressure measured value in the refrigerating machine by correcting the atmospheric pressure, which is the reference value of the sensor of the atmosphere open type, in the first embodiment.

Hereinafter, the operation of the refrigerating machine 1 of the present embodiment will be described with reference to FIG. 3.

During operation of the refrigerating machine 1, the refrigerating machine 1 measures the internal pressure of the condenser 3, the intermediate cooler 4, and the evaporator 5, using the sensors 7 attached to each of the condenser 3, the intermediate cooler 4, and the evaporator 5. An atmospheric pressure which is a reference value of the sensor 7 may deviate from the standard atmospheric pressure that is an ideal value (1013 hpa (hereinafter the same)). Therefore, the control device 6 corrects the atmospheric pressure that is the reference value of the sensor 7 to reduce the influence of the environment in which the refrigerating machine 1 is installed on the measured values of the sensor 7 by compensating for the fluctuation of the atmospheric pressure due to the altitude at which the refrigerating machine 1 is installed and the weather. The atmospheric pressure that is the reference value of the sensor 7 is corrected, using the atmospheric pressure of the location in which the refrigerating machine 1 is installed.

In the present embodiment, step S1 is performed before the trial operation in the factory, steps S2 to S4 are performed at the time of the trial operation in the factory, and steps S5 and S51 are performed at the time of operation of the refrigerating machine 1 in the location in which the refrigerating machine 1 is actually used.

In the present embodiment, first, in step S1, it is determined whether the atmospheric pressure gauge 8 is installed in the refrigerating machine 1. In the present embodiment, since it corresponds to “Yes” in a block “whether the atmospheric pressure gauge is installed” of step S1 in FIG. 3, the process proceeds to step S2.

Steps S2 and S3 are processes for correcting an error due to the accuracy of each sensor. In step S2, during the operation of the refrigerating machine 1 at a manufacturing factory of the refrigerating machine 1, the pressure in the condenser 3, the intermediate cooler 4 and the evaporator 5 is measured using the sensor 7 to acquire the factory actual measured pressure.

Further, in step S2, the pressure in the condenser 3, the intermediate cooler 4, and the evaporator 5 is measured during the operation of the refrigerating machine 1, using a calibration sensor (not shown) for measuring a pressure which is a reference for each sensor, and a calibration device pressure of the sensor is acquired.

In the next step S3, a difference between the calibration device pressure and the factory actual measured pressure is obtained as the factory calibration pressure. The factory calibration pressure is a value for correcting an error due to the accuracy for each sensor. In a later step, the factory calibration pressure is added to the value measured by the sensor 7 to compensate for differences in each sensor.

In step S4, a factory final pressure, which is a measured value of the pressure in the condenser 3, the intermediate cooler 4, and the evaporator 5 during the operation of the refrigerating machine 1, is obtained. As described above, as the value measured by the sensor 7, the atmospheric pressure that deviates from the standard atmospheric pressure may be used as a reference value depending on the location in which the refrigerating machine 1 is located. The factory final pressure is a pressure in which the influence on the location (altitude and weather) in which the refrigerating machine 1 exists is reduced (refer to formula (2) to be described later).

Subsequently, in step S5, it is determined whether the atmospheric pressure gauge 8 is installed in the refrigerating machine 1 as in step S1. Since the present embodiment corresponds to “Yes” in the block “whether the atmospheric pressure gauge is installed” of step S5 in FIG. 3, the process proceeds to step S51. As described above, when the operation of the refrigerating machine 1 is controlled, the pressure in the condenser 3, the intermediate cooler 4, and the evaporator 5 is measured using the sensor 7. As this measured value, the atmospheric pressure that deviates from the standard atmospheric pressure may be used as a reference value, depending on the location in which the refrigerating machine 1 is installed. Therefore, in step S51, the pressure measured by the sensor 7 is corrected using the following formula.

Field final pressure=field actual measured pressure+factory calibration pressure+(field actual measured atmospheric pressure−standard atmospheric pressure) (1)

In formula (1), the field actual measured atmospheric pressure is the atmospheric pressure of the location in which the refrigerating machine 1 is actually used. For example, when the atmospheric pressure of the location in which the refrigerating machine 1 is installed is 1000 hPa, if (1013-1000) hPa (thus 13 hPa) is added to the measured value of the sensor 7, the reference value of the sensor 7 should be 1013 hPa. In the present embodiment, the atmospheric pressure that is the reference value of the sensor 7 is corrected on the basis of this principle. Therefore, the control device 6 obtains the corrected atmospheric pressure, by subtracting the current field actual measured atmospheric pressure actually measured using the atmospheric pressure gauge 8 from the standard atmospheric pressure, which is an ideal reference value, on the basis of formula (1). Further, the control device 6 makes the pressure value measured under the sensor 7 correspond to a case where the pressure value is measured by the standard atmospheric pressure, by adding the obtained corrected atmospheric pressure to the field actual measured pressure measured by the sensor 7. In the present embodiment, in this way, the influence due to the fluctuation in atmospheric pressure depending on the location in which the refrigerating machine 1 is installed and the weather is reduced.

Further, the control device 6 controls the operation of the refrigerating machine 1, using the calculated field final pressure.

In step S4, the same process as step S51 is also performed. That is, in step S4, the factory final pressure is obtained by the following formula (2).

Factory final pressure=factory actual measured pressure+factory calibration pressure+(factory atmospheric pressure−standard atmospheric pressure) (2)

In formula (2), the factory atmospheric pressure is the atmospheric pressure of the location in which the factory is installed. The control device 6 obtains a corrected atmospheric pressure by subtracting the factory atmospheric pressure actually measured using the atmospheric pressure gauge 8 from the standard atmospheric pressure through formula (2). Further, the control device 6 makes the measured value of the pressure in the refrigerating machine 1 measured in the factory correspond to the measured value measured under the standard atmospheric pressure, by adding the obtained corrected atmospheric pressure to the factory actual measured pressure measured by the sensor 7. Further, the control device 6 controls the operation of the refrigerating machine 1, using the factory final pressure as a measured value of the sensor 7.

In the present embodiment, the influence of fluctuations in atmospheric pressure caused by the altitude of the location in which the refrigerating machine 1 is installed and the weather is compensated for, using the atmospheric pressure gauge 8. Therefore, the measured value of the sensor 7 corresponds to the case of being measured in a standard atmospheric pressure environment, and the pressure in the refrigerating machine 1 can be measured accurately. Therefore, the present embodiment can control operation of the refrigerating machine 1 more appropriately. Moreover, since the measured value of the sensor 7 corresponds to the case of being measured in a standard atmospheric pressure environment, the pressure in the refrigerating machine 1 can be measured under substantially the same conditions no matter where the refrigerating machine 1 is installed.

### Second Embodiment

Subsequently, a second embodiment of the present invention will be described. In the present embodiment, the refrigerating machine 1 is not equipped with the atmospheric pressure gauge 8. Therefore, in the present embodiment, the present actual atmospheric pressure cannot be measured to reduce the influence due to the altitude of the location in which the refrigerating machine 1 is installed, and the weather. In the present embodiment, only the influence of fluctuations in atmospheric pressure due to the altitude at which the refrigerating machine 1 is installed is compensated. Differences between the present embodiment and the first embodiment are only that the atmospheric pressure gauge 8 is not installed and the configuration associated therewith. Therefore, hereinafter, only differences between the second embodiment of the present invention and the first embodiment will be described, and description of the same configuration as that of the first embodiment will not be provided.

In the flowchart of FIG. 3, steps S1, S11 and S12 are performed before the trial operation in the factory, steps S2 to S4 are performed at the time of the operation in the factory, and steps S5 and S52 are performed at the time of the trial operation of the refrigerating machine 1 in the location in which the refrigerating machine 1 is actually used.

As shown by step S1 in FIG. 3, first, it is determined whether the atmospheric pressure gauge 8 is installed in the refrigerating machine 1. In the present embodiment, since the atmospheric pressure gauge is not installed in the refrigerating machine 1, it corresponds to “No” in the block “whether the atmospheric pressure gauge is installed” of step S1 in FIG. 3, and the process proceeds to step S11.

In step S11, the altitude of the manufacturing factory of the refrigerating machine and the location in which the refrigerating machine is actually installed is checked, using the control device 6. In the present embodiment, the refrigerating machine 1 is equipped with an altitude acquisition unit (acquisition means) having a global navigation satellite system (GNSS) function provided in the control device 6, and the control device 6 including the altitude acquisition unit constitutes a correcting means for correcting an atmospheric pressure that is a reference value of the sensor 7. The altitude acquisition unit automatically acquires the position information of the manufacturing factory of the refrigerating machine 1 and the location in which the refrigerating machine 1 is installed through the GNSS function. Further, the altitude acquisition unit acquires the altitude by an address retrieval on the Geographical Survey Institute map from the automatically acquired position information. Subsequently, in step S12, the control device 6 obtains the atmospheric pressure of the manufacturing factory of the refrigerating machine 1 and the location in which the refrigerating machine 1 is installed from the acquired altitude, using the following formula (3).

Ph=P0×[1−0.0065×h/(T0+273.15)]5.257 (3)

In formula (3), P0 is the standard atmospheric pressure (1013 hPa), “T0” is the standard temperature (20° C.), and “h” is the altitude (height) [m] at which the refrigerating machine 1 is installed. Formula (3) is a general formula showing a correspondence between the altitude and the atmospheric pressure at the altitude derived on the basis of past knowledge and the like. Further, in other embodiments, the formula used by the control device 6 is not limited to formula (3).

Steps S2, S3, and S5 are the same as those in the first embodiment, and are therefore description thereof will not be repeated. In step S52, the control device 6 substitutes the altitude atmospheric pressure Ph obtained by the formula (3) in place of the field actual measured atmospheric pressure in the above formula (1) to obtain the field final pressure. Similarly, in step S4, the control device 6 also substitutes the altitude atmospheric pressure Ph obtained by the formula (3) in place of the factory atmospheric pressure in the above formula (2) to obtain the factory final pressure. Further, the control device 6 controls the operation of the refrigerating machine 1, using the field actual measured atmospheric pressure and the factory final pressure as the measured values of the sensor 7.

In the present embodiment, even if the atmospheric pressure gauge 8 is not installed, the actually measured pressure in the refrigerating machine 1 can be corrected by correcting an atmospheric pressure which is a reference value of the sensor 7, and the influence of the difference in altitude depending on the location can be reduced. Therefore, in the present embodiment, operation of the refrigerating machine 1 can be controlled more appropriately. Further, in the present embodiment, since the atmospheric pressure gauge is not installed, it is possible to correct an atmospheric pressure which is a reference value of the sensor 7 with a simpler configuration than that of the first embodiment. Further, in the present embodiment, although it is not possible to reduce the influence of the weather on the atmospheric pressure, in an example, since the atmospheric pressure of 11.3 kPa changes at an altitude of 0 m to 1000 m, correction of the measured value of the sensor is sufficiently effective, simply even by correcting the fluctuation of the atmospheric pressure caused by only the altitude.

Further, in the first embodiment, although the atmospheric pressure gauge 8 is mounted on the substrate of the control device 6, if it is possible to measure the atmospheric pressure of the location in which the refrigerating machine 1 is installed, the atmospheric pressure gauge 8 may be installed anywhere, such as the inside of the refrigerating machine 1 or a freezer in which the refrigerating machine 1 is disposed.

In first embodiment, although the control device 6 is configured to be used for control of the refrigerating machine 1 by referring to the measured result of the atmospheric pressure gauge 8 continuously in real time, the control device 6 may be configured to be used for control of the refrigerating machine 1 by referring to the measured value of the atmospheric pressure gauge 8 at a fixed time interval.

In first and second embodiments, although the sensor 7 is attached to the condenser 3, the intermediate cooler 4, and the evaporator 5, respectively, the sensor 7 may be attached to any one or only two of the condenser 3, the intermediate cooler 4, and the evaporator 5. Further, the sensor 7 may be attached to any of the respective constituent elements of the refrigerating machine 1.

Further, in another embodiment, a refrigerating machine that does not equipped with the intermediate cooler 4 may be used. In this case, the sensor 7 may be provided in any one or both of the condenser 3 and the evaporator 5.

In the first and second embodiments, although the atmospheric pressure which is the reference value of the sensor 7 and the factory actual measured pressure are corrected also in the factory using the formula (2), this process may be omitted.

In the second embodiment, although the checking of the location in which the refrigerating machine 1 is installed and the altitude of the factory is performed before the calibration of the pressure at the factory, the checking can be performed at any time point such as the time at which the refrigerating machine 1 is installed and operated in the field.

Moreover, in second embodiment, the atmospheric pressure of the location in which the refrigerating machine 1 is installed was obtained by checking the altitude by searching on the Geographical Survey Institute map to reduce the influence of the altitude on which the refrigerating machine 1 is installed. However, it is also possible to obtain the atmospheric pressure of the location in which the refrigerating machine 1 is installed, for example, by checking the atmospheric pressure from Meteorological Agency. In this way, as long as it is possible to obtain the atmospheric pressure of the location in which the refrigerating machine 1 is installed, any means can be used. Furthermore, although the altitude of the installation location of the refrigerating machine 1 was configured to be acquired automatically by an acquisition means in second embodiment, an operator may manually perform an input to the control device 6 via an input device (not shown) to set the altitude of the location in which the refrigerating machine 1 is installed.

### Third Embodiment

Subsequently, a third embodiment will be described. In the first and second embodiments, the “refrigerating machine” equipped with the correcting unit for correcting the atmospheric pressure that is the reference value of the sensor of the atmosphere open type has been described. The third embodiment is a “hot water heat pump” provided with a correcting means for correcting an atmospheric pressure that is a reference value of a sensor of the atmosphere open type.

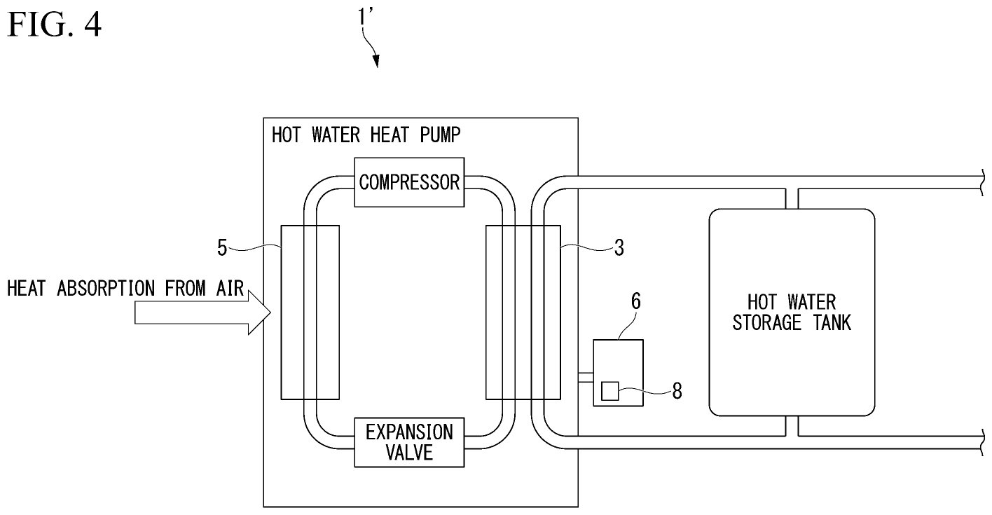

FIG. 4 is a configuration diagram of the hot water heat pump according to the third embodiment.

As shown in FIG. 4, a hot water heat pump 1′ is equipped with a condenser 3, an evaporator 5, a control device 6, and an atmospheric pressure gauge 8. Further, although not shown, the condenser 3 and the evaporator 5 are provided with an atmospheric open type sensor 7. The control device 6 controls the entire hot water heat pump 1′ on the basis of the pressure measured value of the sensor 7.

As in the first embodiment, the control device 6 compensates for the influence of the fluctuation of the atmospheric pressure caused by the altitude of the location in which the refrigerating machine 1 is installed and the weather, using the measured result of the atmospheric pressure gauge 8.

The hot water heat pump 1′ absorbs heat from the air by the evaporator 5 and releases heat to the hot water by the condenser 3. The hot water generated in this way is stored in a hot water storage tank.

Further, the hot water heat pump according to a modified example of the third embodiment may be an aspect which is not equipped with the atmospheric pressure gauge 8. That is, like the refrigerating machine 1 according to the second embodiment, the control device 6 has an altitude acquisition unit having a global navigation satellite system (GNSS) function. The control device 6 calculates the atmospheric pressure of the location in which the hot water heat pump 1′ is installed on the basis of the altitude acquired by the altitude acquiring unit. Then, an atmospheric pressure which is a reference value of the sensor 7 is corrected, using the difference between the atmospheric pressure of the location in which the hot water heat pump 1′ is installed and the standard atmospheric pressure.

Further, in each of the above-described embodiments, the procedures of various processes of the control device 6 described above are stored in a computer-readable recording medium in the form of a program, and the various processes are performed by reading and executing the program using the computer. Further, the computer-readable recording medium refers to a magnetic disk, a magneto-optical disk, a CD-ROM, a DVD-ROM, a semiconductor memory, or the like. Alternatively, the computer program may be distributed to the computer via a communication line, and the computer that has received the distribution may execute the program.

The program may be for realizing some of the above-described functions. Furthermore, the program may be a so-called difference file (a difference program) that can realize the function mentioned above in combination with the program already recorded on the computer system. Furthermore, the control device 6 may be configured with one computer, and may be configured with a plurality of computers connected in a communicable manner.

Although several embodiments of the present invention have been described above, these embodiments are presented as examples and are not intended to limit the scope of the invention. These embodiments can be implemented in various other forms, and various omissions, replacements, and changes can be made without departing from the scope of the invention. These embodiments and modifications thereof are included in the invention described in the claims and equivalents thereof in the same manner as included in the scope and gist of the invention.

### INDUSTRIAL APPLICABILITY

According to the refrigerating machine, the hot water heat pump, the operating method, and the program of the present invention, it is possible to correct the error of the sensor caused by the environment in which the refrigerating machine or the hot water heat pump is installed, and to control the refrigerating machine or the hot water heat pump to be more appropriately operated.

### REFERENCE SIGNS LIST

1 Refrigerating machine
1′ Hot water heat pump
2 Centrifugal compressor
3 Condenser
4 Intermediate cooler
5 Evaporator
6 Control device
7 Sensor
8 Atmospheric pressure gauge

1.-12. (canceled)

13. A refrigerating machine comprising:
a centrifugal compressor which is configured to compress refrigerant;
a condenser and an evaporator through which the refrigerant flows inside;
a sensor attached to at least one of the condenser and the evaporator, the sensor being a sensor of the atmosphere open type configured to measure a pressure inside at least one of the condenser and the evaporator; and
a correcting unit which is configured to acquire an atmospheric pressure of a location in which the refrigerating machine is installed and correct the pressure measured by the sensor on the basis of the atmospheric pressure.

14. The refrigerating machine according to claim 13, wherein the correcting unit is an atmospheric pressure gauge, and
the pressure measured by the sensor is corrected, using a difference between the atmospheric pressure indicated by the atmospheric pressure gauge and a standard atmospheric pressure.

15. The refrigerating machine according to claim 13, further comprising:
an acquisition unit configured to acquire an altitude of a location in which the refrigerating machine is installed from a predetermined database, on the basis of position information of the location in which the refrigerating machine is installed,
wherein the correcting unit is configured to calculate the atmospheric pressure of the location in which the refrigerating machine is installed on the basis of the altitude acquired by the acquisition unit, and
the pressure measured by the sensor is corrected, using the difference between the atmospheric pressure of the location in which the refrigerating machine is installed and a standard atmospheric pressure.

16. The refrigerating machine according to claim 13, wherein the refrigerant is a low-pressure refrigerant in which a pressure at the time of rated operation is 0.2 MPa or less.

17. A hot water heat pump comprising:
a centrifugal compressor which is configured to compress a refrigerant;
a condenser and an evaporator through which the refrigerant flows inside,
a sensor attached to at least one of the condenser and the evaporator, the sensor being a sensor of the atmosphere open type configured to measure a pressure inside at least one of the condenser and the evaporator; and
a correcting unit which is configured to acquire an atmospheric pressure of a location in which the hot water heat pump is installed and correct the pressure measured by the sensor on the basis of the atmospheric pressure.

18. The hot water heat pump according to claim 17, wherein the correcting unit is an atmospheric pressure gauge, and
the pressure measured by the sensor is corrected, using a difference between the atmospheric pressure indicated by the atmospheric pressure gauge and a standard atmospheric pressure.

19. The hot water heat pump according to claim 17, further comprising:
an acquisition unit configured to acquire an altitude of a location in which the hot water heat pump is installed from a predetermined database, on the basis of position information of the location in which the hot water heat pump is installed,
wherein the correcting unit is configured to calculate the atmospheric pressure of the location in which the hot water heat pump is installed on the basis of the altitude acquired by the acquisition unit, and
the pressure measured by the sensor is corrected, using a difference between the atmospheric pressure of the location in which the hot water heat pump is installed and a standard atmospheric pressure.

20. The hot water heat pump according to claim 17, wherein the refrigerant is a low-pressure refrigerant in which a pressure at the time of rated operation is 0.2 MPa or less.

21. An operating method of a refrigerating machine or a hot water heat pump equipped with a centrifugal compressor configured to compress refrigerant, a condenser and an evaporator, the refrigerant flowing inside the condenser and the evaporator, and a sensor of the atmosphere open type attached to at least one of the condenser and the evaporator, the method comprising:
a pressure measurement step of measuring a pressure inside at least one of the condenser and the evaporator, using the sensor;
an atmospheric pressure acquisition step of acquiring an atmospheric pressure of a location in which the refrigerating machine or the hot water heat pump is installed;
a correction step of correcting a measured value of the sensor, using the atmospheric pressure acquired in the step of acquiring the atmospheric pressure; and
a control step of controlling the operation of the refrigerating machine or the hot water heat pump, using a corrected measured value of the sensor.

22. The operating method according to claim 21, wherein an atmospheric pressure gauge is used in the atmospheric pressure acquisition step, and
the pressure measured by the sensor is corrected, using a difference between the atmospheric pressure indicated by the atmospheric pressure gauge and a standard atmospheric pressure, in the correction step.

23. The operating method according to claim 21, wherein the atmospheric pressure acquisition step comprises:
an acquisition step of acquiring an altitude of a location in which the refrigerating machine or the hot water heat pump is installed from a predetermined database, on the basis of position information of the location in which the refrigerating machine or the hot water heat pump is installed; and
an atmospheric pressure calculating step of calculating an atmospheric pressure of the location in which the refrigerating machine or the hot water heat pump is installed, on the basis of the altitude acquired in the acquisition step, and
in the correction step, the pressure measured by the sensor is corrected, using a difference between the atmospheric pressure of the location in which the refrigerating machine or the hot water heat pump is installed and a standard atmospheric pressure.

24. A program which causes a control device of a refrigerating machine or a hot water heat pump equipped with a centrifugal compressor configured to compress refrigerant, a condenser and an evaporator, the refrigerant flowing inside the condenser and the evaporator, and a sensor of the atmosphere open type attached to at least one of the condenser and the evaporator to function as
a pressure measurement unit which is configured to measure a pressure inside at least one of the condenser and the evaporator, using the sensor;
an atmospheric pressure acquisition unit which is configured to acquire an atmospheric pressure of a location in which the refrigerating machine or the hot water heat pump is installed;
a correction unit which is configured to correct a measured valued of the, using the atmospheric pressure acquired in a step of acquiring the atmospheric pressure; and
a control unit which is configured to control the operation of the refrigerating machine or the hot water heat pump, using a corrected measured value of the sensor.
